(19) United States
(12) Patent Application Publication
(10) Pub. No.: US 2024/0094366 A1
(43) Pub. Date: Mar. 21, 2024

(54) FIGURE OF MERIT TUNING FOR SONAR

(71) Applicant: NAVICO HOLDING AS, Egersund (NO)

(72) Inventor: Jayme J. Caspall, Tulsa, OK (US)

(21) Appl. No.: 17/946,263

(22) Filed: Sep. 16, 2022

(51) Int. Cl. G01S 7/52; G01S 15/89

(52) U.S. Cl. CPC G01S 7/52003; G01S 15/89

(57) ABSTRACT

A sonar transducer system is provided having a display and a sonar transducer assembly having a transmitter configured to transmit sonar signals. The transmitter has a peak transmit sensitivity occurring at a first frequency. The sonar transducer assembly has a receiver configured to receive return sonar signals, with the receiver having a peak receive sensitivity occurring at a second frequency. The transmitter and the receiver share a same facing direction and are provided as physically separate components. At least one of the transmitter or the receiver is tuned so that the peak transmit sensitivity and the peak receive sensitivity occur at a same frequency. The sonar transducer assembly is configured to improve the peak transmit sensitivity and/or the peak receive sensitivity to generate a sonar image having a greater quality, and the sonar image may be presented on the display.

### FIELD OF THE INVENTION

Embodiments of the present invention relate generally to systems, assemblies, and methods for tuning separate transmit and receive transducer elements for enhancing the resultant sonar imagery.

### BACKGROUND OF THE INVENTION

Active sonar produces images from the time record of the signals detected by the receiving elements. These signals are caused by the echoes of the sound emitted by the transmitting elements. In order to save cost and reduce complexity, the typical single beam system uses a single transducer element (perhaps comprised of multiple sound-sensitive structures) for both the transmit and receive functions. However, where this is done, the peak transmit sensitivity and the peak receive sensitivity occur at two different operating frequencies. For example, the peak receive sensitivity frequently occurs at a higher operating frequency than the peak transmit sensitivity. This difference in operating frequency for the two peaks often occurs as a result of small voltages feeding into a front end of an amplifier once a sonar signal has been transmitted due to changing of the electromechanics during transmission and receiving. Consequently, the transducer element may perform at a suboptimal level, with the overall sensitivity and with the resulting sonar data and sonar images generated from the transducer element being suboptimal.

### BRIEF SUMMARY OF THE INVENTION

In various embodiments, a system is provided with sonar units having a separate transmitter and receiver. By providing a separate transmitter and receiver, the transmitter and/or the receiver may be tuned separately from each other to ensure that the peak transmit sensitivity and the peak receive sensitivity arise at the same frequency. In contrast, where only a single transceiver is provided that transmits sonar signals and receives sonar returns, the peak transmit sensitivity and the peak receive sensitivity may occur at different operating frequencies and it is not be possible to tune the transmit and/or receive portions of the transceiver so that these peaks arise at the same operating frequency.

A figure of merit value is defined as the sum of the transmit sensitivity and the receive sensitivity at the current operating frequency, with the figure of merit value, the transmit sensitivity, and the receive sensitivity provided in decibels. By tuning the transmitter and/or the receiver to provide the peak transmit sensitivity and the peak receive sensitivity at the same frequency, the operating frequency may be set at this frequency and the figure of merit value may be optimized. The optimization of this figure of merit value may result a higher overall sensitivity for a sonar transducer assembly and may also result in high quality sonar data having an improved signal-to-noise ratio. Optimization of the figure of merit value may also result in higher quality sonar images, allowing the user to make more well-informed navigational decisions. Tuning may be performed in-situ in some embodiments, with other components of the receiver and/or transmitter being provided and connected as they typically would be.

In an example embodiment, a sonar transducer system is provided. The system has a display and a sonar transducer assembly. The sonar transducer assembly includes a transmitter that is configured to transmit sonar signals, with the transmitter having a peak transmit sensitivity occurring at a first frequency. The sonar transducer assembly also includes a receiver that is configured to receive return sonar signals, with the receiver having a peak receive sensitivity occurring at a second frequency. The transmitter and the receiver share a same facing direction. Additionally, the transmitter and the receiver are provided as physically separate components, and at least one of the transmitter or the receiver is tuned so that the peak transmit sensitivity and the peak receive sensitivity occur at a same frequency. The sonar transducer assembly is configured to improve at least one of the peak transmit sensitivity or the peak receive sensitivity to generate a sonar image having a greater quality. The display is configured to present the sonar image.

In some embodiments, a figure of merit value is defined as a sum of a transmit sensitivity at the operating frequency and the receive sensitivity at the same operating frequency. Furthermore, tuning at least one of the transmitter or the receiver so that peak transmit sensitivity and the peak receive sensitivity occur at the same frequency may result in an increase in the figure of merit value of 4 decibels or more. In some related embodiments, the increase in the figure of merit value may enhance an overall sensitivity of the sonar transducer assembly, and the increase in the figure of merit value may enhance the signal-to-noise ratio of the sonar.

In some embodiments, the transmitter may be provided with transmit electromechanics, and the receiver may be provided with receive electromechanics. At least one of the transmitter or the receiver may be tuned by adjusting the transmit electromechanics and/or the receive electromechanics. In some related embodiments, the transmit electromechanics may include a transmit crystal and the receive electromechanics may include a receive crystal. In additional related embodiments, the transmitter and/or the receiver may be tuned by adjusting the shape of the transmit crystal and/or the receive crystal. In further related embodiments, the transmitter and/or the receiver may be tuned by adjusting the size of the transmit crystal and/or the receive crystal. Further, in some embodiments, the receiver may be tuned by adjusting the width of the receive crystal in the receive electromechanics.

In some embodiments, the receive crystal may include a receiving face and the transmit crystal may include a transmitting face. The receiving face and the transmitting face may have a width ranging from 0.5 millimeters to 6 millimeters, from 0.75 millimeters to 4 millimeters, or from 1 millimeter to 3.8 millimeters. The receiving face and the transmitting face may possess a wide variety of lengths, and, in some embodiments, lengths may range from 20 millimeters to 400 millimeters, from 68 millimeters to 350 millimeters, or from 200 millimeters to 300 millimeters. Additionally, in some embodiments, the transmitter and the receiver may be provided as electrically separate components.

In another example embodiment, a sonar transducer assembly is provided having a transmitter that is configured to transmit sonar signals, with the transmitter having a peak transmit sensitivity occurring at a first frequency. The sonar transducer assembly also has a receiver that is configured to receive return sonar signals, with the receiver having a peak receive sensitivity occurring at a second frequency. The transmitter and the receiver share a same facing direction, and the second frequency is initially different from the first frequency. Additionally, the transmitter and the receiver are provided as physically separate components, and the transmitter and/or the receiver is configured to be tuned so that the peak transmit sensitivity and peak receive sensitivity occur at a same frequency. The sonar transducer assembly is configured to improve at least one of the transmit sensitivity or the receive sensitivity to generate a sonar image having a greater quality.

In some embodiments, a figure of merit value is defined as a sum of a transmit sensitivity at the operating frequency and the receive sensitivity at the same operating frequency. Further, tuning the transmitter and/or the receiver so that peak transmit sensitivity and the peak receive sensitivity occur at the same frequency may result in an increase in the figure of merit value of 4 decibels or more. In some related embodiments, the increase in the figure of merit value may increase an overall sensitivity of the sonar transducer assembly, and the increase in the figure of merit value may enhance the signal-to-noise ratio of the sonar.

In some embodiments, the transmitter may be provided with transmit electromechanics, and the receiver may be provided with receive electromechanics. The transmitter and/or the receiver may be configured to be tuned by adjusting the transmit electromechanics and/or the receive electromechanics. In some related embodiments, the transmit electromechanics may include a transmit crystal and the receive electromechanics may include a receive crystal. In further related embodiments, the transmitter and/or the receiver may be configured to be tuned by adjusting the transmit crystal and/or the receive crystal. In additional related embodiments, the transmitter and/or the receiver may be configured to be tuned by adjusting the size of the transmit crystal and/or the receive crystal. Additionally, in some embodiments, the receiver may be configured to be tuned by adjusting the width of the receive crystal in the receive electromechanics. Furthermore, in some embodiments, the transmitter and the receiver may be used to form a side scan, a forward scan, or a down scan.

In another example embodiments, a method of tuning a sonar transducer assembly is provided. The method includes providing a transmitter that is configured to transmit sonar signals, with the transmitter having a peak transmit sensitivity occurring at a first frequency. The method also includes providing a receiver that is configured to receive return sonar signals, with the receiver having a peak receive sensitivity occurring at a second frequency. The second frequency is different from the first frequency. The transmitter and the receiver are provided as physically separate components, and the method also includes orienting the transmitter and the receiver so that the transmitter and the receiver share a same facing direction. Additionally, the method includes tuning the transmitter and/or the receiver so that the peak transmit sensitivity and the peak receive sensitivity occur at a same frequency. Tuning the transmitter and/or the receiver improves the transmit sensitivity and/or the receive sensitivity to generate a sonar image having a greater quality.

### BRIEF DESCRIPTION OF THE DRAWINGS

Having thus described the invention in general terms, reference will now be made to the accompanying drawings, which are not necessarily drawn to scale, and wherein:

FIG. 1 illustrates a side view of an example watercraft including various marine devices, in accordance with some embodiments discussed herein;

FIG. 2A illustrates a perspective view of a sonar transducer assembly with a sonar unit having separate transmitters and receivers, in accordance with some embodiments discussed herein;

FIG. 2B illustrates a front schematic view of a sonar unit with a transmitter and receiver provided therein, in accordance with some embodiments discussed herein;

FIG. 2C illustrates a schematic view with dimensions of a transmitter and receiver, in accordance with some embodiments discussed herein;

FIGS. 3A-3B illustrate a plot showing the transmit sensitivity and the receive sensitivity as a function of frequency, in accordance with some embodiments discussed herein;

FIG. 4 illustrates a schematic view of a display presenting a sonar image thereon, in accordance with some embodiments discussed herein;

FIG. 5 illustrates a block diagram of an example system with various electronic devices, marine devices, and secondary devices shown, in accordance with some embodiments discussed herein; and

FIG. 6 illustrates a method of optimizing the figure of merit value, in accordance with some embodiments discussed herein.

### DETAILED DESCRIPTION

Example embodiments of the present invention now will be described more fully hereinafter with reference to the accompanying drawings, in which some, but not all embodiments of the invention are shown. Indeed, the invention may be embodied in many different forms and should not be construed as limited to the example embodiments set forth herein; rather, these embodiments are provided so that this disclosure will satisfy applicable legal requirements. Like reference numerals generally refer to similar elements throughout. For example, reference numbers 160 and 560 are each intended to refer to similar marine electronic devices. Additionally, any connections or attachments may be direct or indirect connections or attachments unless specifically noted otherwise.

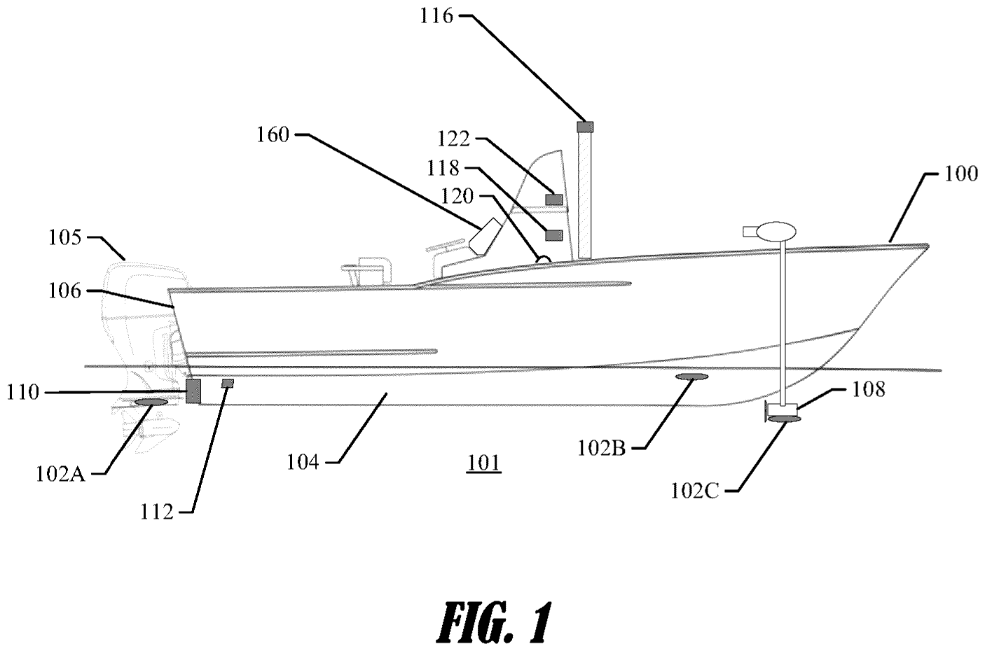

FIG. 1 illustrates an example watercraft 100 including various marine devices, in accordance with some embodiments discussed herein. As depicted in FIG. 1, the watercraft 100 (e.g., a vessel) is configured to traverse a marine environment, e.g. body of water 101, and may use one or more sonar transducer assemblies 102A, 102B, and 102C disposed on and/or proximate to the watercraft 100. Notably, example watercraft 100 contemplated herein may be surface watercraft, submersible watercraft, or any other implementation known to those skilled in the art. The sonar transducer assemblies 102A, 102B, and 102C may each include one or more sonar transducer elements configured to transmit sound waves into the body of water 101, receive sonar returns from the body of water 101, and convert the sonar returns into sonar return data. Various types of sonar transducers may be provided—for example, a linear downscan sonar transducer, a conical downscan sonar transducer, a sonar transducer array, or a sidescan sonar transducer may be used.

Depending on the configuration, the watercraft 100 may include a primary motor 105, which may be a main propulsion motor such as an outboard or inboard motor. Additionally, the watercraft 100 may include a trolling motor 108 configured to propel the watercraft 100 or maintain a position. The one or more sonar transducer assemblies (e.g., 102A, 102B, and/or 102C) may be mounted in various positions and to various portions of the watercraft 100 and/or equipment associated with the watercraft 100. For example, the sonar transducer assembly may be mounted to the transom 106 of the watercraft 100, such as depicted by sonar transducer assembly 102A. The sonar transducer assembly may be mounted to the bottom or side of the hull 104 of the watercraft 100, such as depicted by sonar transducer assembly 102B. The sonar transducer assembly may be mounted to the trolling motor 108, such as depicted by transducer assembly 102C.

The watercraft 100 may also include one or more marine electronic devices 160, such as may be utilized by a user to interact with, view, or otherwise control various aspects of the various sonar systems described herein. In the illustrated embodiment, the marine electronic device 160 is positioned proximate the helm (e.g., steering wheel) of the watercraft 100 although other locations on the watercraft 100 are contemplated. Likewise, additionally or alternatively, a remote device (such as a user's mobile device) may include functionality of a marine electronic device.

The watercraft 100 may also comprise other components within the one or more marine electronic devices 160 or at the helm. For example, a display may be provided in the marine electronic device 160 or at the helm. In FIG. 1, the watercraft 100 comprises a radar 116, which is mounted at an elevated position (although other positions relative to the watercraft 100 are also contemplated). The watercraft 100 also comprises an AIS transceiver 118, a direction sensor 120, and a camera 122, and these components are each positioned at or near the helm (although other positions relative to the watercraft 100 are also contemplated). Additionally, the watercraft 100 comprises a rudder 110 at the stern of the watercraft 100, and the rudder 110 may be positioned on the watercraft 100 so that the rudder 110 rests in the body of water 101. In other embodiments, some of these components may be integrated into the marine electronic devices 160 or other devices. Another example device on the watercraft 100 includes a temperature sensor 112 that may be positioned so that it rests within or outside of the body of water 101. Thus, the temperature sensor 112 may measure the air temperature or the temperature of the body of water 101. Other example devices include a wind sensor, one or more speakers, and various vessel devices/features (e.g., doors, bilge pump, fuel tank, etc.), among other things. Additionally, one or more sensors may be associated with marine devices; for example, a sensor may be provided to detect the position of the primary motor 105, the trolling motor 108, or the rudder 110. A position sensor may also be provided in the marine electronic device 160 or at another location. The position sensor may comprise a GPS, bottom contour, inertial navigation system, such as machined electromagnetic sensor (MEMS), a ring laser gyroscope, or another location detection system. Other sensors may also be provided on the watercraft 100, including but not limited to a current sensor, a light sensor, a wind sensor, and a speed sensor. Other sensors may be provided to measure the pitch of the watercraft 100, a heave of the watercraft 100, a sway of the watercraft 100, a roll of the watercraft 100, a yaw of the watercraft 100, an autopilot drive activity, a drive load, or a rudder angle.

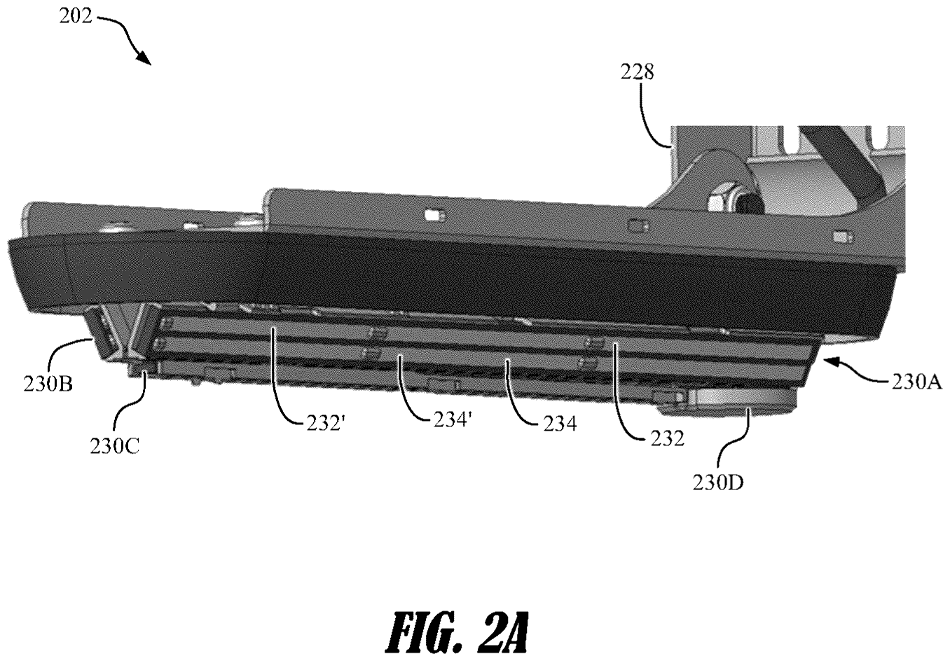

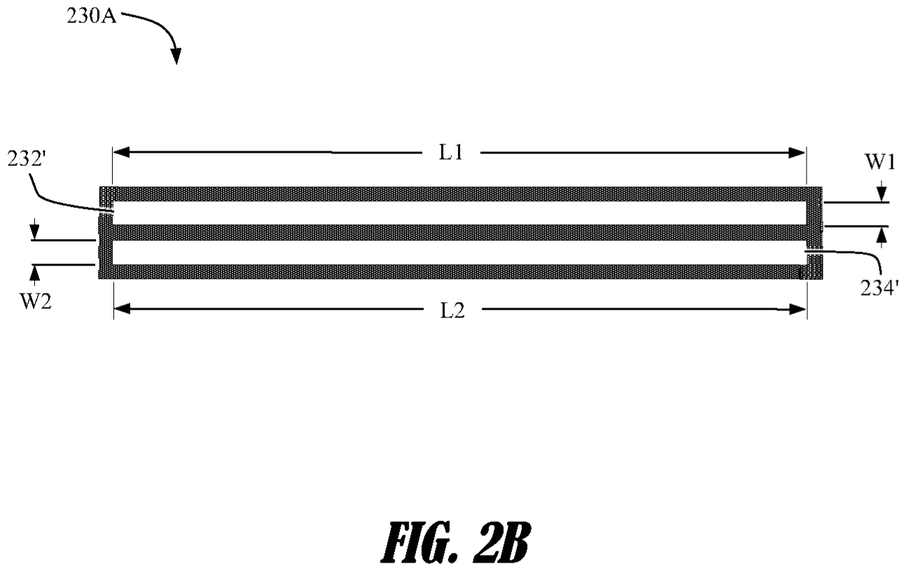

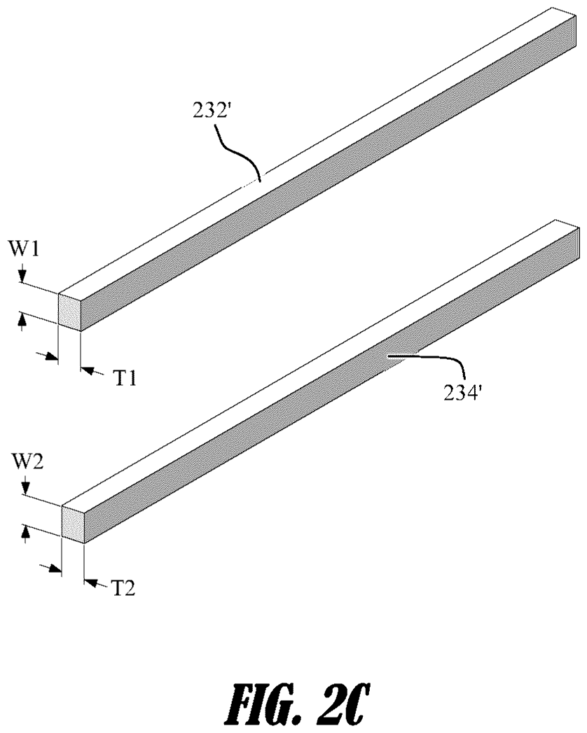

While some sonar transducer assemblies 102A, 102B, 102C are illustrated in FIG. 1, further details of an example sonar transducer assembly 202 are illustrated in the perspective view of FIG. 2A. The sonar transducer assembly 202 has a first sonar unit 230A having a separate transmitter 232 and receiver 234. The transmitter 232 may have its own transmit electromechanics, and these transmit electromechanics may include one or more transmit crystals 232′, which may be referred to herein as a transmit crystal 232′ (e.g., two or more transmit crystals may be placed end-to-end and electrically connected (e.g. through solder bumps) to act as a single transmit crystal). Additionally, the receiver 234 may have its own receive electromechanics, and these receive electromechanics may include one or more receive crystals 234′, which may be referred to herein as a receive crystal 234′ (e.g., two or more receive crystals may be placed end-to-end and electrically connected (e.g. through solder bumps) to act as a single receive crystal). The receive electromechanics of the receiver 234 may be generally separate from the transmit electromechanics of the transmitter 232, and the transmit crystal 232′ may be physically separated from the receive crystal 234′. Additionally, in some embodiments, the transmit crystal 232′ may be provided as an electrically separate component from the receive crystal 234′, with the transmit crystal 232′ and the receive crystal 234′ provided in separate electrical circuits. The transmitter 232 may be configured to transmit sonar signals, and the receiver 234 may be configured to receive return sonar signals. Additionally, the transmitter 232 and the receiver 234 or the crystals thereof may be oriented so that they possess approximately the same facing direction. This may be accomplished by installing the transmitter 232 and the receiver 234 or the crystals thereof in recesses within a sonar unit 230A in some embodiments.

As illustrated, the sonar transducer assembly 202 may include a mounting bracket 228 to assist in securing the sonar transducer assembly 202 to the watercraft 100 (see FIG. 1). For example, the mounting bracket 228 may be used to secure the sonar transducer assembly 202 to the transom 106 (see FIG. 1) of the watercraft 100.

In the sonar transducer assembly 202, a first sonar unit 230A, a second sonar unit 230B, a third sonar unit (e.g., linear downscan) 230C, and a fourth sonar unit (e.g., conical downscan) 230D are provided. However, the sonar transducer assembly 202 may have one or more sonar units provided therein in other embodiments. Notably, the second sonar unit 230B may mirror the construction and set-up of the first sonar unit 230A to form sidescan sonar imagery using both the first sonar unit 230A and the second sonar unit 230B. The front of the first sonar unit 230A is visible in FIG. 2A, and the transmitter 232 and the receiver 234 of the first sonar unit 230A may be seen from the perspective provided in FIG. 2A. By providing a first sonar unit 230A having a separate transmit crystal 232′ and receive crystal 234′, the sensitivity of the transmitter 232 and the receiver 234 may be separately tuned. Thus, to the extent that peak transmit sensitivity occurs at a first frequency and peak receive sensitivity occurs at a second frequency that is different from the first frequency, the transmitter 232 and/or the receiver 234 may be tuned so that the peak transmit sensitivity occurs at the same frequency as the peak receive sensitivity. In this way, the overall figure of merit value (i.e. the sum of the transmit sensitivity (in decibels) and the receive sensitivity (in decibels) at the current operating frequency) may be optimized, and the sonar data generated by the first sonar unit 230A and the sonar transducer assembly 202 may be improved. Further, optimization of the overall figure of merit value may result in the generation of sonar images having a greater quality.

The different sonar units (e.g., 230A and 230B) may each be directed at different angles, and in some embodiments, different sonar transducers 202 may be oriented at different angles as well. In this way, sonar coverage may be provided as desired by the user. In some embodiments, the transmitter 232 and the receiver 234 of a given sonar unit (e.g. 230A) may be used to form sidescan, forwardscan, or downscan, but the sonar units may be oriented in a variety of other manners.

FIGS. 2B-2C illustrate other views of an example first sonar unit where further dimensions of the transmit crystal and the receive crystal may be seen. FIG. 2B illustrates a front schematic view of the first sonar unit 230A with a transmit crystal 232′ and receive crystal 234′ provided therein, and FIG. 2C illustrates a schematic view with dimensions of a transmit crystal 232′ and receive crystal 234′. As illustrated in FIG. 2B, the transmit crystal 232′ may possess a length (L1) and a width (W1). Furthermore, as illustrated in FIG. 2C, the transmit crystal 232′ may have a thickness (T1). The receive crystal 234′ may possess a length (L2) and a width (W2) as illustrated in FIG. 2B, and the receive crystal 234′ may also possess a thickness (T2) as illustrated in FIG. 2C. The lengths L1, L2 may range from 20 millimeters to 400 millimeters, from 68 millimeters to 350 millimeters, or from 200 millimeters to 300 millimeters in some embodiments, but other lengths may be used as well. Additionally, the widths W1, W2 may range from 0.5 millimeters to 6 millimeters, from 0.75 millimeters to 4 millimeters, or from 1 millimeter to 3.8 millimeters in some embodiments. Further, the thicknesses T1, T2 may range from 0.75 millimeters to 3.8 millimeters or from 1 millimeter to 3.3 millimeters in some embodiments. However, other widths and thicknesses may be used for the crystals. Furthermore, the size of the crystals may be varied to appropriately tune the transmitter or the receiver, and the sizes of the crystals may differ. For example, widths W1, W2 may possess different values in some scenarios.

Tuning of the transmitter 232 or the receiver 234 may occur in a variety of ways. This may be done by changing the size of the transmit crystal 232′ and/or the receive crystal 234′. The size may be changed by altering the width (W1) of the transmit crystal 232′ and/or by changing the width (W2) of the receive crystal 234′. By changing the width, the crystals may switch between a width mode (e.g. a 455 mode) and a thickness mode (e.g. an 800 mode), and higher modes may result in the receiver and/or the transmitter generating sonar data with a higher resolution. Tuning may also be performed by changing the thickness (T1) of the transmit crystal 232′ and/or by changing the thickness (T2) of the receive crystal 234′. Additionally or alternatively, the transmit crystal 232′ or the receive crystal 234′ may be tuned by making adjustments to other portions of the transmit electromechanics and/or the receive electromechanics, such as adjusting a shape (e.g., shaving a slope into one or more sides, introducing a cut into one or more sides, etc.). Tuning may be performed solely at the receiver 234 in some embodiments, with the transmitter 232 being unmodified. The crystals may be shaped precisely to meet the design needs using a dicing saw or some other approach.

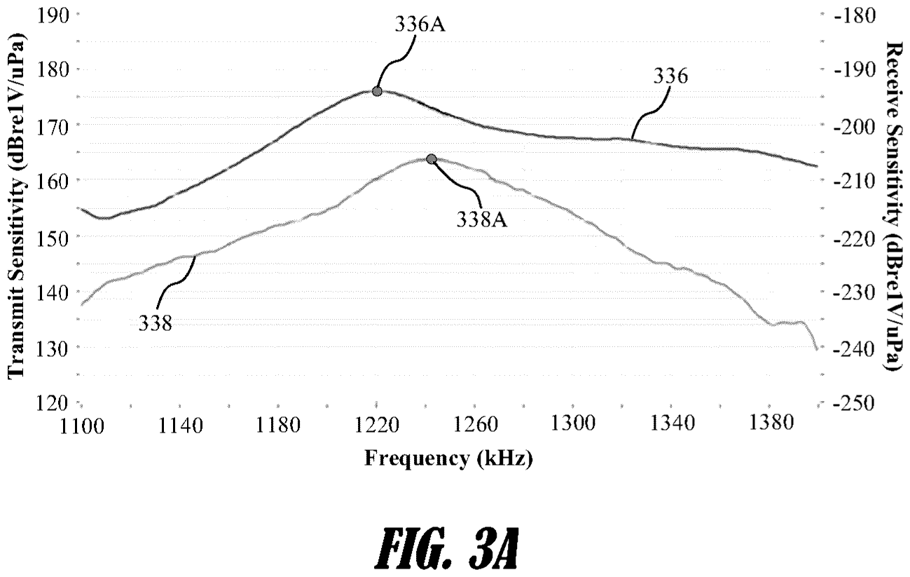

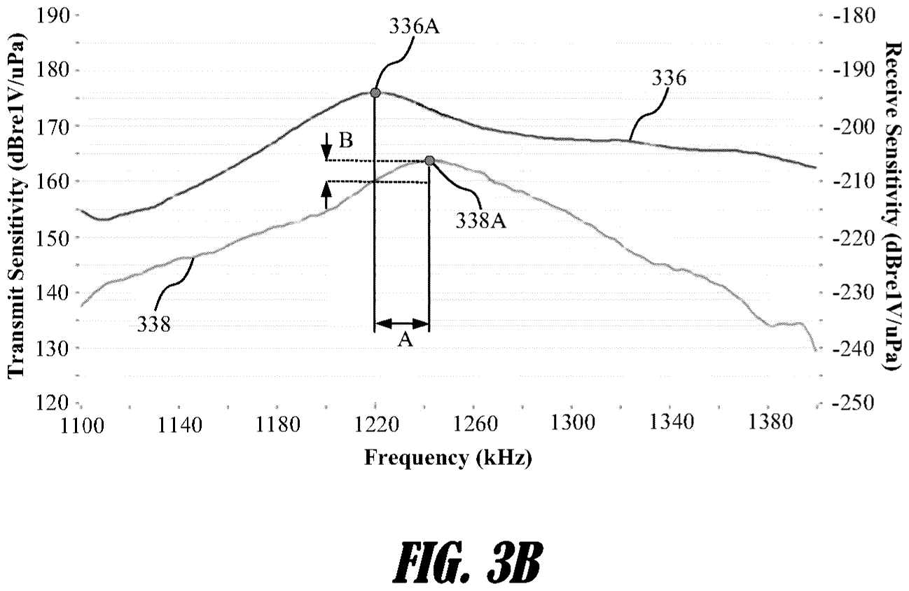

As noted above, a transmitter and/or a receiver may be tuned to optimize the overall sensitivity of the sonar unit. This tuning is further explained below in reference to the plots of FIGS. 3A-3B. FIGS. 3A-3B illustrate a plot showing the transmit sensitivity function 336 and the receive sensitivity function 338. The transmit sensitivity function 336 may provide the transmit sensitivity as a function of the operating frequency, and the receive sensitivity function 338 may provide the receive sensitivity as a function of the operating frequency. The transmit sensitivity values are provided on the left y-axis, the receive sensitivity values are provided on the right y-axis, and the operating frequency is provided on the x-axis. As illustrated in FIG. 3A, the transmit sensitivity function 336 may possess a peak transmit sensitivity 336A and the receive sensitivity function 338 may possess a peak receive sensitivity 338A. As illustrated in FIG. 3B, the peak transmit sensitivity 336A may occur at a first frequency and the peak receive sensitivity 338A may occur at a second frequency, with the first frequency and the second frequency being different from each other. In the illustrated embodiment, the first frequency is approximately 1220 kHz and the second frequency is approximately 1242 kHz. Here, as is normal, the second frequency (for the peak receive sensitivity) is higher than the first frequency. The frequency offset (A) shows the difference between the first frequency where the peak transmit sensitivity 336A arises and the second frequency where the peak receive sensitivity 338A arises. In the illustrated embodiment, the frequency offset (A) is approximately 22 kHz. Because the transmit crystal 232′ and the receive crystal 234′ are provided separately from each other, the transmit crystal 232′ and/or the receive crystal 234′ may be tuned independently of each other to reduce the frequency offset (A). By reducing the frequency offset (A) to zero (or near thereto), the peak transmit sensitivity 336A and the peak receive sensitivity 338A may occur at the same frequency. When that frequency is utilized as the operating frequency for the transmit crystal 232′ and the receive crystal 234′, the figure of merit value may be optimized to achieve a figure of merit value improvement (B). In the illustrated embodiment, the figure of merit value improvement is greater than 4 decibels.

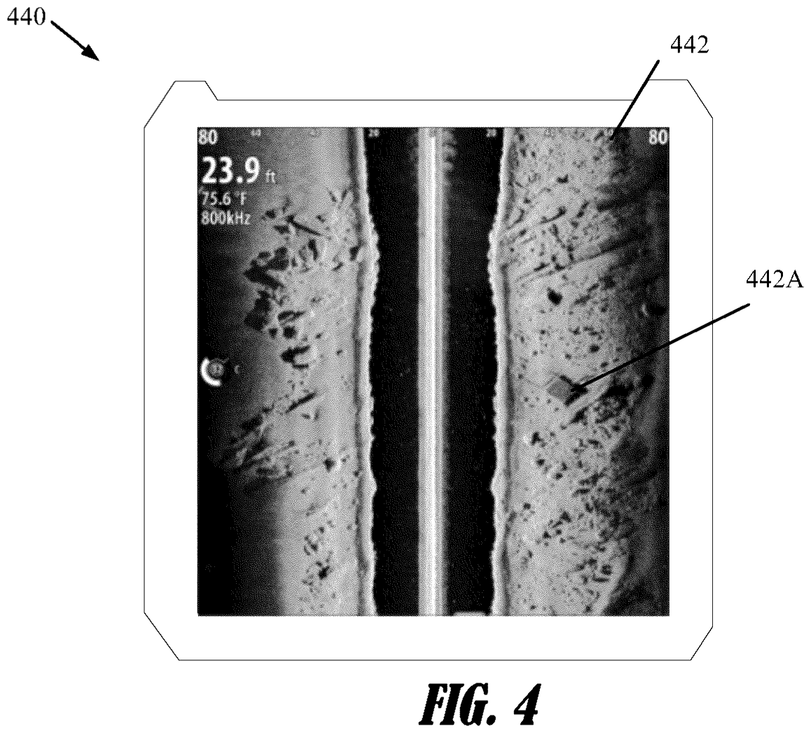

FIG. 4 illustrates a schematic view of a display 440 presenting a sonar image 442 thereon. Where the figure of merit value is optimized as discussed above, sonar data that is generated may possess a higher quality, and the sonar data may possess an improved signal-to-noise ratio. Optimization of the figure of merit value may also result in higher quality sonar images, allowing the user to make more well-informed navigational decisions. For example, the sonar images generated may permit users to detect objects of interest in the water such as structure 442A at a higher likelihood of detection.

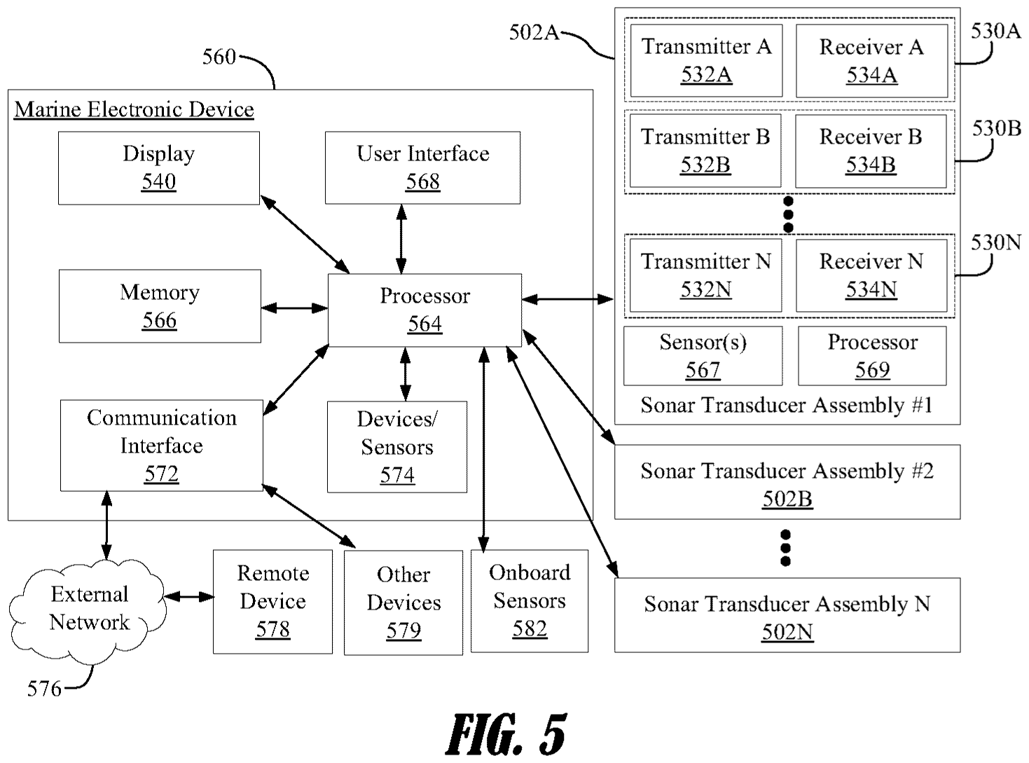

A variety of electrical devices and components may be used in the systems described herein. FIG. 5 illustrates a block diagram of an example system with various electronic devices, marine devices, and secondary devices shown. The system may include one or more sonar transducer assemblies. In this illustrated embodiment, a first sonar transducer assembly 502A, a second sonar transducer assembly 502B, and a final sonar transducer assembly 502N are provided. However, a greater or lesser number of sonar transducer assemblies may be used. The first sonar transducer assembly 502A may also include one or more sonar units therein. For example, the first sonar transducer assembly 502A includes a first sonar unit 530A, a second sonar unit 530B, and a final sonar unit 530N. However, a greater or lesser number of sonar units may be provided in the first sonar transducer assembly 502A. Other sonar transducer assemblies (e.g. second sonar transducer assembly 502B, final sonar transducer assembly 502N, etc.) may similarly have sonar units. The sonar units may each include a separate transmitter and receiver (although some sonar units in the assembly may not include separate transmitters and receivers). For example, the first sonar unit 530A has a first transmitter 532A and a first receiver 534A, the second sonar unit 530B has a second transmitter 532B and a second receiver 534B, and the final sonar unit 530N has a final transmitter 532N and a final receiver 534N. The sonar transmitters may be arranged to operate alone or in one or more arrays.

In some embodiments, additional separate sonar transmitters (arranged to operate alone, in an array, or otherwise) may be included. As indicated herein, the sonar transducer assemblies 502A, 502B, 502N may also include a sonar signal processor 569 or other processor configured to perform various sonar processing. Alternatively, there may not be a sonar signal processor 569 in the sonar transducer assemblies and processing may occur, for example, remotely from the sonar transducer assemblies, such as at an intermediate housing (e.g., a black box) or at the marine electronic device 560 (e.g., via processor 564) or other remote device. In some embodiments, the processor (e.g., at least one processor 564 in the marine electronic device 560, a controller (or processor portion) in the sonar transducer assemblies 502A, 502B, 502N, or a remote controller—or combinations thereof) may be configured to filter sonar return data and/or selectively control elements of the sonar transducer assemblies 502A, 502B, 502N. For example, various processing devices (e.g., a multiplexer, a spectrum analyzer, A-to-D converter, etc.) may be utilized in controlling or filtering sonar return data and/or transmission of sonar signals from the transmitter(s).

The sonar transducer assemblies 502A, 502B, 502N may also include one or more other systems, such as various sensor(s) 567. For example, the sonar transducer assemblies 502A, 502B, 502N may include an orientation sensor, such as gyroscope or other orientation sensor (e.g., accelerometer, MEMS, etc.) that can be configured to determine the relative orientation of the sonar transducer assemblies 502A, 502B, 502N, the relative orientation of a sonar unit, or the relative orientation of a transmitter or receiver. In some embodiments, additionally or alternatively, other types of sensor(s) are contemplated, such as, for example, a water temperature sensor, a current sensor, a light sensor, a wind sensor, a speed sensor, or the like. The sensor(s) 567 may assist in determining the orientation of the sonar transducer assemblies 502A, 502B, 502N or certain components thereof.

The illustrated system includes a marine electronic device 560. The system may comprise numerous marine devices. The marine electronic device 560 may include at least one processor 564, a memory 566, a communication interface 572, a user interface 568, a display 540, and one or more sensors 574 (e.g. position sensor, direction sensor, other sensors, etc.). One or more of the components of the marine electronic device 560 may be located within a housing or could be separated into multiple different housings (e.g., be remotely located). One or more marine devices may be implemented on the marine electronic device 560. For example, a position sensor, a direction sensor, an autopilot, and other devices or sensors 574 may be provided within the marine electronic device 560. These marine devices can be integrated within the marine electronic device 560, integrated on a watercraft at another location and connected to the marine electronic device 560, and/or the marine devices may be implemented at a remote device 578 in some embodiments.

The processor(s) 564 may be any means configured to execute various programmed operations or instructions stored in a memory device (e.g., memory 566) such as a device or circuitry operating in accordance with software or otherwise embodied in hardware or a combination of hardware and software (e.g. a processor operating under software control or the processor embodied as an application specific integrated circuit (ASIC) or field programmable gate array (FPGA) specifically configured to perform the operations described herein, or a combination thereof) thereby configuring the device or circuitry to perform the corresponding functions of the processor(s) 564 as described herein. In this regard, the processor(s) 564 may be configured to analyze electrical signals communicated thereto to provide or receive sonar data from one or more sonar transducer assemblies and additional (e.g., secondary) data from other sources. For example, the processor(s) 564 may be configured to receive data from onboard sensors and additional data, determine an expected output value, and/or determine a watercraft operation change.

In some embodiments, the processor(s) 564 may be further configured to implement signal processing. In some embodiments, the processor(s) 564 may be configured to perform enhancement features to improve the display characteristics of data or images, collect or process additional data, such as time, temperature, GPS information, waypoint designations, or others, or may filter extraneous data to better analyze the collected data. The processor(s) 564 may further implement notices and alarms, such as those determined or adjusted by a user, to reflect proximity of other objects (e.g., represented in sonar data), to reflect proximity of other vehicles (e.g. watercraft), approaching storms, hazards, fish, etc.

In an example embodiment, the memory 566 may include one or more non-transitory storage or memory devices such as, for example, volatile and/or non-volatile memory that may be either fixed or removable. The memory 566 may be configured to store instructions, computer program code, sonar data, and additional data such as radar data, chart data, location/position data in a non-transitory computer readable medium for use, such as by the processor(s) 564 for enabling the marine electronic device 560 to carry out various functions in accordance with example embodiments of the present invention. For example, the memory 566 could be configured to buffer input data for processing by the processor(s) 564. Additionally or alternatively, the memory 566 could be configured to store instructions for execution by the processor(s) 564.

Other devices 579 may also be provided in the system such as a radar, a rudder, a primary motor, a trolling motor, an autopilot, and additional sensors/devices may also be provided as marine devices. However, other marine devices may be provided as well. The system may comprise any number of different systems, modules, or components, and each of these may include any device or means embodied in either hardware, software, or a combination of hardware and software configured to perform one or more corresponding functions described herein.

The communication interface 572 may be configured to enable communication to external systems (e.g. an external network 576). In this manner, the marine electronic device 560 may retrieve stored data from a remote device 578 via the external network 576 in addition to or as an alternative to the onboard memory 566. Additionally or alternatively, the marine electronic device 560 may transmit or receive data, such as sonar signal data, sonar return data, sonar image data, or the like to or from a sonar transducer assembly 502A, 502B, 502N. In some embodiments, the marine electronic device 560 may also be configured to communicate with other devices or systems (such as through the external network 576 or through other communication networks, such as described herein). For example, the marine electronic device 560 may communicate with a propulsion system of the watercraft 100 (see FIG. 1) (e.g., for autopilot control); a remote device (e.g., a user's mobile device, a handheld remote, etc.); or another system. Using the external network 576, the marine electronic device may communicate with and send and receive data with external sources such as a cloud. The marine electronic device may send and receive various types of data. For example, the system may receive weather data, map information, alert data, etc. However, this data is not required to be communicated using external network 576, and the data may instead be communicated using other approaches, such as through a physical or wireless connection via the communications interface 572.

The communications interface 572 of the marine electronic device 560 may also include one or more communications modules configured to communicate with one another in any of a number of different manners including, for example, via a network. In this regard, the communications interface 572 may include any of a number of different communication backbones or frameworks including, for example, Ethernet, the NMEA 2000 framework, GPS, cellular, Wi-Fi, Bluetooth, Bluetooth Low Energy (“BLE”) or other suitable networks. The network may also support other data sources, including GPS, autopilot, engine data, compass, radar, etc. In this regard, numerous other peripheral devices (including other marine electronic devices or sonar transducer assemblies) may be included in the system.

The position sensor may be configured to determine the current position and/or location of the marine electronic device 560 (and/or the watercraft 100 (see FIG. 1)). For example, the position sensor may comprise a GPS, bottom contour, inertial navigation system, such as machined electromagnetic sensor (MEMS), a ring laser gyroscope, or other location detection system. Alternatively or in addition to determining the location of the marine electronic device 560 or the watercraft 100, the position sensor may also be configured to determine the position and/or orientation of an object outside of the watercraft 100.

The display 540 (e.g. one or more screens) may be configured to present images and may include or otherwise be in communication with a user interface 568 configured to receive input from a user. The display 540 may be, for example, a conventional LCD (liquid crystal display), a touch screen display, mobile device, or any other suitable display known in the art upon which images may be displayed.

In some embodiments, the display 540 may present one or more sets of data (or images generated from the one or more sets of data). Such data includes chart data, radar data, sonar data, weather data, location data, position data, orientation data, sonar data, or any other type of information relevant to the watercraft. Sonar data may be received from one or more sonar transducer assemblies 502A, 502B, 502N or from sonar devices positioned at other locations, such as remote from the watercraft. Additional data may be received from other devices and sensors 574 such as a radar, a primary motor or an associated sensor, a trolling motor or an associated sensor, an autopilot, a rudder or an associated sensor, a position sensor, a direction sensor, a remote device 578, onboard memory 566 (e.g., stored chart data, historical data, etc.), or other devices 579. The other sensors/devices 574 may include, for example, an air temperature sensor, a water temperature sensor, a current sensor, a light sensor, a wind sensor, a speed sensor, or the like. Additionally, the user interface 568 may include, for example, a keyboard, keypad, function keys, mouse, scrolling device, input/output ports, touch screen, or any other mechanism by which a user may interface with the system.

Although the display 540 of FIG. 5 is shown as being directly connected to the processor(s) 564 and within the marine electronic device 560, the display 540 could alternatively be remote from the processor(s) 564 and/or marine electronic device 560. Likewise, in some embodiments, the position sensor and/or user interface 568 could be remote from the marine electronic device 560.

FIG. 5 merely presents an exemplary arrangement of these components. The components presented in FIG. 5 may be rearranged to alter the connections between components. For example, in some embodiments, a marine device outside of the marine electronic device 560, such as the onboard sensors 582, may be directly connected to the communication interface 572 rather than being connected to the processor(s) 564. Some components may be removed and others may be added.

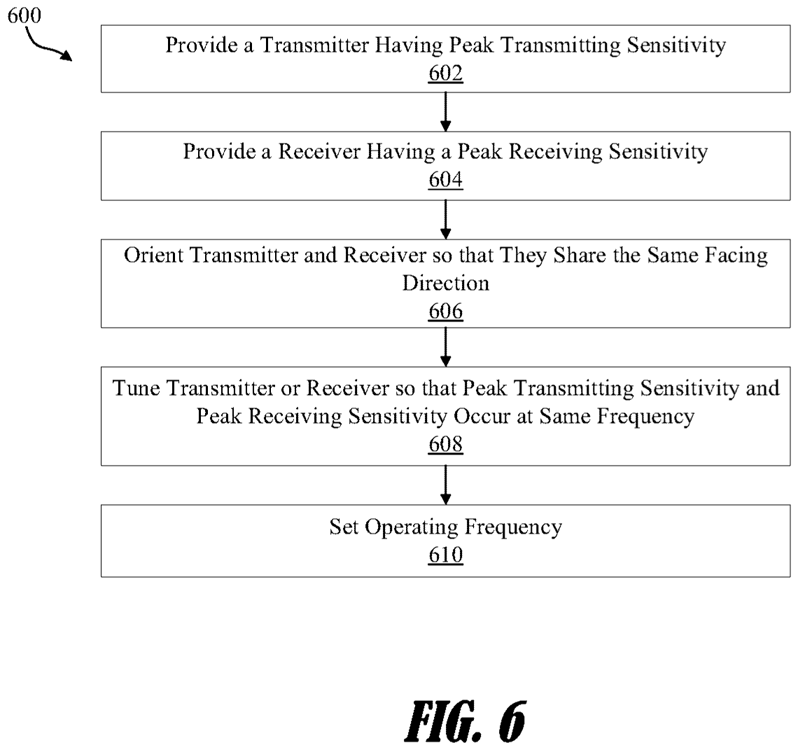

Methods of using the systems and approaches discussed herein are also contemplated. FIG. 6 illustrates a method 600 of optimizing the figure of merit value. At operation 602, a transmitter having a peak transmit sensitivity may be provided. This peak transmit sensitivity may occur at a first frequency, and the transmitter may be configured to transmit sonar signals. Additionally, at operation 604, a receiver having a peak receive sensitivity may be provided. This receiver may be configured to receive return sonar signals. The peak receive sensitivity may occur at a second frequency, and this second frequency may be different from the first sensitivity. This receiver may be a physically separate component from the transmitter.

At operation 606, the transmitter and the receiver are oriented so that they share the same facing direction. This may be accomplished by installing the transmitter and the receiver or the crystals thereof in recesses within a sonar unit (see, e.g., 230A, FIG. 2A) in some embodiments. However, the orientation of the transmitter and/or the receiver may be adjusted in other ways.

At operation 608, the transmitter and/or the receiver are tuned so that the peak transmit sensitivity and the peak receive sensitivity occur at the same frequency. Tuning the transmitter and/or the receiver improves the transmit sensitivity and/or the receive sensitivity, and this results in the generation of a sonar image having a greater quality when the operating frequency is appropriately set. At operation 610, the operating frequency may be set so that the peak transmit sensitivity and the peak receive sensitivity are provided.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

That which is claimed:

1. A sonar transducer system comprising:
a sonar transducer assembly comprising:
a transmitter that is configured to transmit sonar signals, the transmitter having a peak transmit sensitivity occurring at a first frequency; and
a receiver that is configured to receive return sonar signals, the receiver having a peak receive sensitivity occurring at a second frequency; and
a display,
wherein the transmitter and the receiver share a same facing direction, wherein the transmitter and the receiver are provided as physically separate components, wherein at least one of the transmitter or the receiver is tuned so that the peak transmit sensitivity and the peak receive sensitivity occur at a same frequency, wherein the sonar transducer assembly is configured to improve at least one of the peak transmit sensitivity or the peak receive sensitivity to generate a sonar image having a greater quality, wherein the display is configured to present the sonar image.

2. The sonar transducer system of claim 1, wherein a figure of merit value is defined as a sum of a transmit sensitivity at the operating frequency and the receive sensitivity at the same operating frequency, wherein tuning at least one of the transmitter or the receiver so that peak transmit sensitivity and the peak receive sensitivity occur at the same frequency results in an increase in the figure of merit value of 4 decibels or more.

3. The sonar transducer system of claim 2, wherein the increase in the figure of merit value enhances an overall sensitivity of the sonar transducer assembly, wherein the increase in the figure of merit value enhances the signal-to-noise ratio of the sonar.

4. The sonar transducer system of claim 1, wherein the transmitter is provided with transmit electromechanics, wherein the receiver is provided with receive electromechanics, wherein at least one of the transmitter or the receiver is tuned by adjusting at least one of the transmit electromechanics or the receive electromechanics.

5. The sonar transducer system of claim 4, wherein the transmit electromechanics include a transmit crystal and the receive electromechanics include a receive crystal.

6. The sonar transducer system of claim 5, wherein the at least one of the transmitter or the receiver is tuned by adjusting a shape of at least one of the transmit crystal or the receive crystal.

7. The sonar transducer system of claim 5, wherein the at least one of the transmitter or the receiver is tuned by adjusting the size of at least one of the transmit crystal or the receive crystal.

8. The sonar transducer system of claim 7, wherein the receiver is configured to be tuned by adjusting the width of the receive crystal in the receive electromechanics.

9. The sonar transducer system of claim 5, wherein the receive crystal includes a receiving face, wherein the transmit crystal includes a transmitting face, wherein the at least one of the transmitter or the receiver is tuned by adjusting the size of at least one of a shape of the receiving face or the transmitting face.

10. The sonar transducer system of claim 1, wherein the transmitter and the receiver are provided as electrically separate components.

11. A sonar transducer assembly comprising:
a transmitter that is configured to transmit sonar signals, the transmitter having a peak transmit sensitivity occurring at a first frequency;
a receiver that is configured to receive return sonar signals, the receiver having a peak receive sensitivity occurring at a second frequency,
wherein the transmitter and the receiver share a same facing direction, wherein the transmitter and the receiver are provided as physically separate components, wherein at least one of the transmitter or the receiver is tuned so that the peak transmit sensitivity and peak receive sensitivity occur at a same frequency, wherein the sonar transducer assembly is configured to improve at least one of the transmit sensitivity or the receive sensitivity to generate a sonar image having a greater quality.

12. The sonar transducer assembly of claim 11, wherein a figure of merit value is defined as a sum of a transmit sensitivity at the operating frequency and the receive sensitivity at the same operating frequency, wherein tuning at least one of the transmitter or the receiver so that peak transmit sensitivity and the peak receive sensitivity occur at the same frequency results in an increase in the figure of merit value of 4 decibels or more.

13. The sonar transducer assembly of claim 12, wherein the increase in the figure of merit value enhances an overall sensitivity of the sonar transducer assembly, wherein the increase in the figure of merit value enhances the signal-to-noise ratio of the sonar.

14. The sonar transducer assembly of claim 11, wherein the transmitter is provided with transmit electromechanics, wherein the receiver is provided with receive electromechanics, wherein at least one of the transmitter or the receiver is tuned by adjusting at least one of the transmit electromechanics or the receive electromechanics.

15. The sonar transducer assembly of claim 14, wherein the transmit electromechanics include a transmit crystal and the receive electromechanics include a receive crystal.

16. The sonar transducer assembly of claim 15, wherein the at least one of the transmitter or the receiver is tuned by adjusting a shape of at least one of the transmit crystal or the receive crystal.

17. The sonar transducer assembly of claim 16, wherein the at least one of the transmitter or the receiver is tuned by adjusting the size of at least one of the transmit crystal or the receive crystal.

18. The sonar transducer assembly of claim 17, wherein the receiver is tuned by adjusting the width of the receive crystal in the receive electromechanics.

19. The sonar transducer assembly of claim 11, wherein the transmitter and the receiver are used to form side scan sonar imagery, forward scan sonar imagery, or down scan sonar imagery.

20. A method of tuning a sonar transducer assembly comprising:
providing a transmitter that is configured to transmit sonar signals, the transmitter having a peak transmit sensitivity occurring at a first frequency;
providing a receiver that is configured to receive return sonar signals, the receiver having a peak receive sensitivity occurring at a second frequency, wherein the second frequency is different from the first frequency, wherein the transmitter and the receiver are provided as physically separate components;
tuning at least one of the transmitter or the receiver so that the peak transmit sensitivity and the peak receive sensitivity occur at a same frequency; and
orienting the transmitter and the receiver so that the transmitter and the receiver share a same facing direction;
wherein tuning at least one of the transmitter or the receiver improves at least one of the transmit sensitivity or the receive sensitivity to generate a sonar image having a greater quality.
